(19) United States
(12) Patent Application Publication
(10) Pub. No.: US 2024/0047837 A1
(43) Pub. Date: Feb. 8, 2024

(54) METHOD FOR JOINING CURRENT COLLECTOR, COLLECTOR JOINING STRUCTURE, AND BATTERY

(71) Applicant: PRIMEARTH EV ENERGY CO., LTD., Kosai-shi (JP)

(72) Inventor: Shigeki SAITO, Hamamatsu-shi (JP)

(73) Assignee: PRIMEARTH EV ENERGY CO., LTD., Kosai-shi (JP)

(21) Appl. No.: 18/228,463

(22) Filed: Jul. 31, 2023

(30) Foreign Application Priority Data
Aug. 3, 2022 (JP) 2022-124003

(51) Int. Cl. H01M 50/536; H01M 50/533; H01M 10/04; B23K 1/00; B23K 1/005

(52) U.S. Cl. CPC H01M 50/536; H01M 50/533; H01M 10/0431; B23K 1/0016; B23K 1/0056; B23K 2101/38

(57) ABSTRACT

A method for joining a current collector includes (1) providing an electrode body that includes electrode plate end portions overlapping each other in a thickness-wise direction of the electrode plate end portions, (2) providing a current collector including a folded portion, where the folded portion includes two opposing holding walls that hold the electrode plate end portions of the electrode body in between, and a top part that connects the two holding walls and includes an opening, and (3) brazing edges of the electrode plate end portions, exposed from the opening of the top part, to the two holding walls to join the current collector to the electrode body.

### BACKGROUND

### 1. Field

The following description relates to a method for joining a current collector, a collector joining structure, and a battery.

### 2. Description of Related Art

A typical battery, such as a lithium-ion rechargeable battery, includes an electrode body formed by a stack of positive and negative electrodes and a separator held between the positive and negative electrodes. The electrode body is, for example, accommodated in a case and connected to an external terminal by a current collector that serves as a connecting member.

Japanese Laid-Open Patent Publication No. 2000-164195 describes an example of a battery including an electrode body formed by a roll of electrodes and a separator. The electrodes of the electrode body each include an electrode plate end that defines an uncoated portion where an electrode active material is not applied. Further, the electrode plate end of the positive electrode is arranged at one axial end of the electrode body, and the electrode plate end of the negative electrode is arranged at the other axial end of the electrode body. In such a battery, a current collector is joined to each axial end of the electrode body to connect a corresponding one of the positive and negative electrodes to an external terminal.

Specifically, the current collector includes clamps, each holding the corresponding electrode plate end that is rolled into overlapping layers in a thickness-wise direction. Each clamp is formed by bending a metal plate to form two walls oppose each other. The clamp holds overlapping portions of an electrode plate end in a groove formed between the two walls. Ultrasonic welding is performed to join the current collector to the electrode plate end in the clamp.

Further, the walls of each clamp in the current collector include thin portions. This structure avoids “uneven melting” of the electrode plate end portion held in the clamp during ultrasonic welding and increases the joining strength.

### SUMMARY

When ultrasonic welding is performed for the joining of the current collector, it is necessary that a welding machine holds the joining part in the thickness-wise direction of the electrode plate end portions. This may limit the joining position and the joining state of the current collector with respect to the electrode body.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a method for joining a current collector includes providing an electrode body that includes electrode plate end portions overlapping each other in a thickness-wise direction of the electrode plate end portions; providing a current collector including a folded portion, where the folded portion includes two opposing holding walls that hold the electrode plate end portions of the electrode body in between, and a top part that connects the two holding walls and includes an opening; and brazing edges of the electrode plate end portions, exposed from the opening of the top part, to the two holding walls to join the current collector to the electrode body.

The above joining method may further include, prior to the brazing, binding the electrode plate end portions in a state in which the two holding walls compress the electrode plate end portions held between the two holding walls at a position separated from the edges of the electrode plate end portions.

The above joining method may further include arranging a brazing material in the opening by holding the brazing material between the two holding walls at the top part of the folded portion.

With the above joining method, the brazing may be performed by uniformly applying heat to the brazing material in the opening along the edges of the electrode plate end portions.

With the above joining method, the brazing may be performed by irradiating the brazing material in the opening with a laser beam.

In another general aspect, a collector joining structure includes an electrode body, a current collector, and a brazing portion. The electrode body includes electrode plate end portions overlapping each other in a thickness-wise direction of the electrode plate end portions. The current collector includes a folded portion and a top part. The folded portion includes two opposing holding walls that hold the electrode plate end portions of the electrode body in between. The top part connects the two holding walls and includes an opening. The brazing portion joins edges of the electrode plate end portions, exposed from the opening of the top part, to the two holding walls.

The above collector joining structure may further include a compressing-binding portion that binds the electrode plate end portions at a position separated from the edges of the electrode plate end portions in a state in which the two holding walls compress the electrode plate end portions held between the two holding walls.

With the above collector joining structure, an opening end of the opening may be widened in a thickness-wise direction of the electrode plate end portions.

With the above collector joining structure, the electrode plate end portions may include first electrode plate end portions having a first polarity and second electrode plate end portions having a second polarity differing from the first polarity. The electrode body may be a rolled body that includes a first axial end at which the first electrode plate end portions are arranged and a second axial end at which the second electrode plate end portions are arranged. The electrode body may have a flattened roll shape including a first flat surface and a second flat surface facing opposite directions. At the first axial end, the current collector may be joined to a long portion at a side of the first flat surface. At the second axial end, the current collector may be joined to a long portion at a side of the second flat surface.

In another general aspect, a battery includes the above joining structure.

Other features and aspects will be apparent from the following detailed description, the drawings, and the claims.

### BRIEF DESCRIPTION OF THE DRAWINGS

FIG. 1 is a perspective view of a rechargeable battery.

FIG. 2 is an exploded view of an electrode body.

FIG. 3 is a side view of the rechargeable battery.

FIG. 4 is a side view of the electrode body and a current collector.

FIG. 5 is a side view of the electrode body and the current collector.

FIG. 6 is a side view showing a folded portion of the current collector and electrode plate end portions.

FIG. 7 is a diagram illustrating how the current collector is attached to the electrode plate end portions.

FIG. 8 is a plan view showing a joining portion of the current collector.

FIG. 9 is a cross-sectional view showing the folded portion of the current collector and the electrode plate end portions.

FIG. 10 is a cross-sectional view showing the folded portion of the current collector and the electrode plate end portions.

FIG. 11 is a diagram illustrating brazing.

FIG. 12 is a diagram illustrating brazing.

FIG. 13 is a plan view showing joining positions of the current collectors on the electrode body.

FIGS. 14A and 14B are side views showing the joining positions of the current collectors on the electrode body.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

An embodiment related to a method for joining a current collector and a joining structure will now be described with reference to the drawings.

Rechargeable Battery

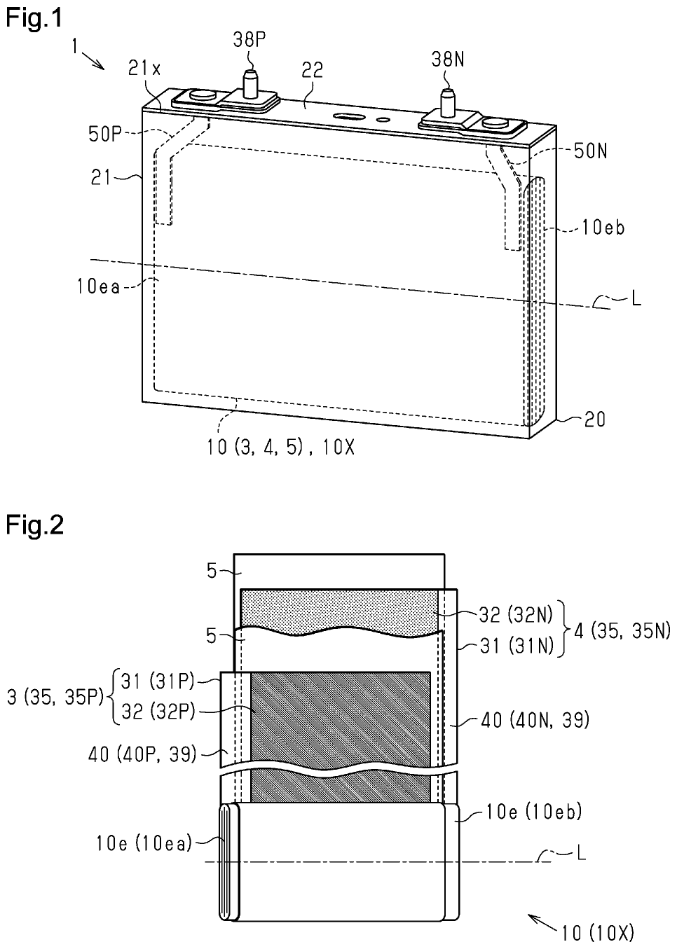

As shown in FIG. 1, a rechargeable battery 1 includes an electrode body 10 and a case 20. A positive electrode 3, a negative electrode 4, and separators 5 are integrated into the electrode body 10. The case 20 accommodates the electrode body 10. The electrode body inside the case 20 is impregnated with a non-aqueous electrolyte (not shown).

Specifically, sheets of the positive electrode 3, the negative electrode 4, and the separator 5 are stacked in the rechargeable battery 1. The stack of the positive electrode 3, the negative electrode 4, and the separator 5 is rolled with the separator 5 held in between the positive electrode 3 and the negative electrode 4 to form the electrode body 10. The electrode body 10 is structured as a rolled body 10X in which the electrodes and the separators 5 are disposed in a radial direction.

Further, the case 20 includes a flat box-shaped case body 21 and a lid 22 that closes an open end 21x of the case body 21. The electrode body 10 structured as the rolled body has a flattened roll shape in correspondence with the box shape of the case 20.

Electrode Sheet and Electrode Body

As shown in FIG. 2, each of the positive electrode 3 and the negative electrode 4 includes an electrode sheet 35. The electrode sheet 35 includes a sheet-shaped electrode plate 31 and an electrode active material layer 32 formed on the electrode plate 31.

Specifically, in an electrode sheet 35P of the positive electrode 3, a mixture paste including a lithium transition metal oxide, serving as a positive electrode active material, is applied to an electrode plate 31P of the positive electrode 3 formed from aluminum and the like. In an electrode sheet 35N of the negative electrode 4, a mixture paste including a carbon-based material, serving as a negative electrode active material, is applied to an electrode plate 31N of the negative electrode 4 formed from copper and the like. Each mixture paste includes a binder. The mixture pastes are dried so that a positive electrode active material layer 32P and a negative electrode active material layer 32N are formed on the positive and negative electrode sheets 35P and 35N, respectively.

The positive and negative electrode sheets 35P and 35N are shaped as strips. In the electrode body 10, the positive and negative electrode sheets 35P and 35N are stacked with the separator 5 held in between and rolled about a rolling axis L that extends in a widthwise direction of the strips (sideward direction in FIG. 2).

In FIG. 2, the separators 5 and the electrode sheets 35 are rolled with the electrode sheet 35P of the positive electrode 3 arranged at the inner side. However, this is merely an example of the structure of the electrode body 10. The separator 5 and the electrode sheets 35 may be rolled with the electrode sheet 35N of the negative electrode 4 arranged at the inner side. Such arrangement determines whether the outermost electrode sheet 35 of the electrode body 10 will be the electrode sheet 35P of the positive electrode 3 or the electrode sheet 35N of the negative electrode 4.

External Terminal and Connecting Member

As shown in FIGS. 1 to 3, the lid 22 of the case 20 includes a positive electrode terminal 38P and a negative electrode terminal 38N projecting out of the case 20 as external terminals 38 of the rechargeable battery 1. Further, each electrode sheet 35 includes an uncoated portion 39 where the electrode active material layer 32 is not formed on the electrode plate 31. Specifically, ends of the electrode plates 31P and 31N in the widthwise direction, namely, an electrode plate end 40P of the positive electrode 3 and an electrode plate end 40N of the negative electrode 4, define the uncoated portions 39 of the electrode sheets 35. The mixture pastes including electrode active materials are applied to the strips of the electrode plates 31P and 31N. The uncoated portions 39 electrically connect the electrode sheet 35P of the positive electrode 3 to the positive electrode terminal 38P and the electrode sheet 35N of the negative electrode 4 to the negative electrode terminal 38N.

As shown in FIG. 2, in a state in which the electrode sheets 35 and the separators 5 are rolled, the electrode plate end 40P of the positive electrode 3 structured as the uncoated portion 39 is arranged at a first axial end 10ea of the electrode body 10 (left end in FIG. 2). Further, the electrode plate end 40N of the negative electrode 4 structured as the uncoated portion 39 is arranged at a second axial end 10eb of the electrode body 10 (right end in FIG. 2). Thus, the electrode plate end 40P of the electrode sheet 35P and the electrode plate end 40N of the electrode sheet 35N extend out of the rolled electrode body 10 away from each other in the rolling axis direction.

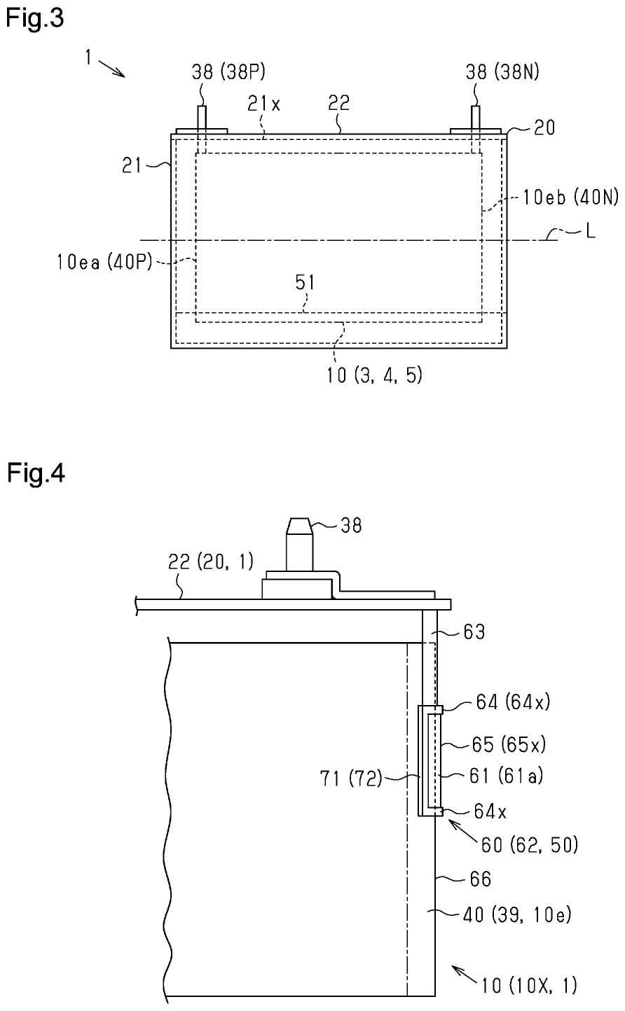

As shown in FIGS. 1 and 3, the electrode body 10 is accommodated in the case 20 in a state in which the rolling axis L of the electrode body 10 is parallel to a longitudinal direction of the lid 22 (sideward direction in FIG. 3). The lid 22 has the form of a substantially elongated rectangular plate. In this state, a connecting member 50P connects the electrode plate end 40P of the positive electrode 3 to the positive electrode terminal 38P, and a connecting member 50N connects the electrode plate end 40N of the negative electrode 4 to the negative electrode terminal 38N.

A fluorine-based electrolyte 51 is injected into the case 20 in a state in which the electrode body 10 is accommodated in the case 20 as described above. A lithium salt serving as a supporting electrolyte is dissolved in an organic solvent to adjust the electrolyte 51. This impregnates the electrode body 10 accommodated in the case 20 with the electrolyte 51.

Current Collector

A current collector joined to the electrode body 10 to form a connecting member between the electrode body 10 and an external terminal in the rechargeable battery 1 of the present embodiment will now be described.

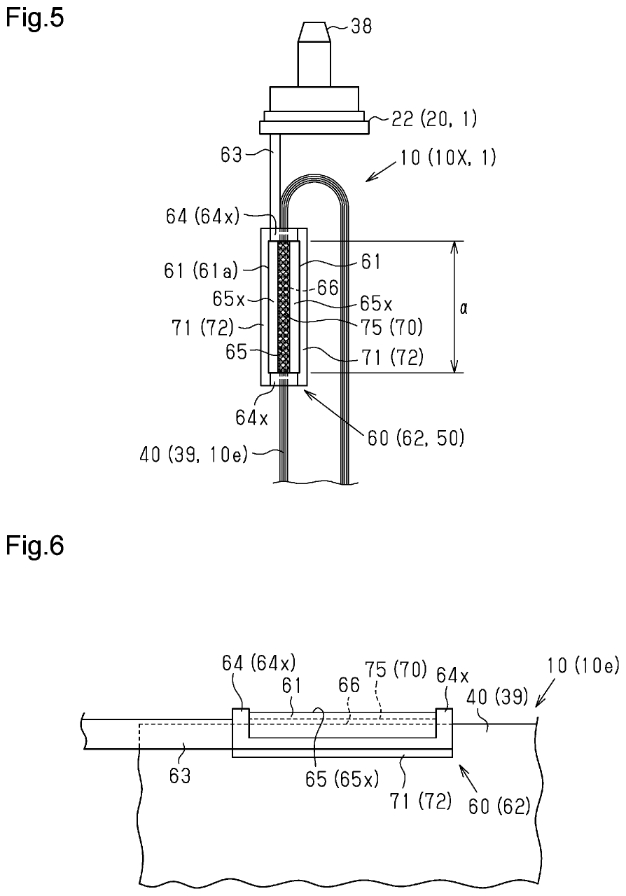

As shown in FIGS. 4 and 5, the electrode body 10 of the present embodiment has the structure of the rolled body 10X. Thus, the positive electrode 3 includes electrode plate end portions 40 overlapping one another in the thickness-wise direction at one axial end 10e of the electrode body 10, and the negative electrode 4 includes electrode plate end portions 40 overlapping one another in the thickness-wise direction at the other axial end 10e of the electrode body 10. In other words, in the electrode body 10 that is the rolled body 10X, the electrode plate end 40P of the positive electrode 3 includes a plurality of electrode plate end portions 40 overlapping one another in the thickness-wise direction at one axial end 10e of the electrode body 10, and the electrode plate end 40N of the negative electrode 4 includes a plurality of electrode plate end portions 40 overlapping one another in the thickness-wise direction at the other axial end 10e of the electrode body 10. Further, the rechargeable battery 1 includes current collectors 60 joined to the axial ends 10e of the electrode body 10. As described above, the positive and negative electrode plate end portions 40 at the axial ends 10e of the electrode body 10 define the uncoated portions 39 where the electrode active material layers 32 are not formed on the electrode plates 31 (refer to FIG. 2). Accordingly, the rechargeable battery 1 uses the current collectors 60 as the positive and negative connecting members 50 that electrically connect the positive electrode 3 and the negative electrode 4 of the electrode body 10 to the positive and negative external terminals 38. Specifically, the positive electrode current collector 60 is used as the positive connecting member 50 that electrically connects the positive electrode 3 to the positive electrode external terminal 38, and the negative electrode current collector 60 is used as the negative connecting member 50 that electrically connects the negative electrode 4 to the negative electrode external terminal 38.

As shown in FIGS. 6 to 8, each current collector 60 includes a folded portion 62 and an extension portion 63. The folded portion 62 includes two opposing holding walls 61. The extension portion 63 is continuous with the folded portion 62.

The current collector 60 is attached to the axial end 10e of the electrode body 10 in a state in which the electrode plate end portions 40 overlapping one another in the thickness-wise direction are held between the two holding walls 61. In this state, the folded portion 62 of the current collector 60 is joined to the axial end 10e of the electrode body 10.

Further, the extension portion 63 connects the current collector 60 to the external terminal 38 (refer to FIGS. 4 and 5). In this manner, the rechargeable battery 1 includes the current collectors 60 acting as the positive and negative connecting members 50 in accordance with the polarities of the electrode plate end portions 40 to which the folded portions 62 are connected.

Each current collector 60 is formed by bending a metal plate (not shown). The current collector 60 is formed from the same material as the electrode plate end portions 40 at the axial end 10e of the electrode body 10 to which the current collector 60 is joined. Specifically, the current collector 60 joined to the electrode plate end portions 40 of the positive electrode 3 is formed from aluminum or the like in the same manner as the electrode plate 31P of the positive electrode 3. Further, the current collector 60 joined to the electrode plate end portions 40 of the negative electrode 4 is formed from copper or the like in the same manner as the electrode plate 31N of the negative electrode 4.

Further, the folded portion 62 of the current collector 60 includes a top part 64 that has a substantially U-shaped cross section and connects the two holding walls 61. The folded portion 62 has a substantially rectangular side shape of which the longitudinal direction is parallel to a direction in which edges 66 of the electrode plate end portions 40 held between the two holding walls 61 extend (sideward direction in FIG. 6). The extension portion 63 extends from one holding wall 61a in the longitudinal direction of the folded portion 62.

Further, the current collector 60 includes an opening 65 in the top part 64 of the folded portion 62. The opening 65 of the current collector 60 is formed in a central part of the folded portion 62 in the longitudinal direction of the folded portion 62. The opening 65 extends in the longitudinal direction of the folded portion 62. The current collector 60 of the present embodiment is configured so that the folded portion 62 is joined to the axial end 10e of the electrode body 10 by performing brazing through the opening 65.

Method for Joining Current Collector

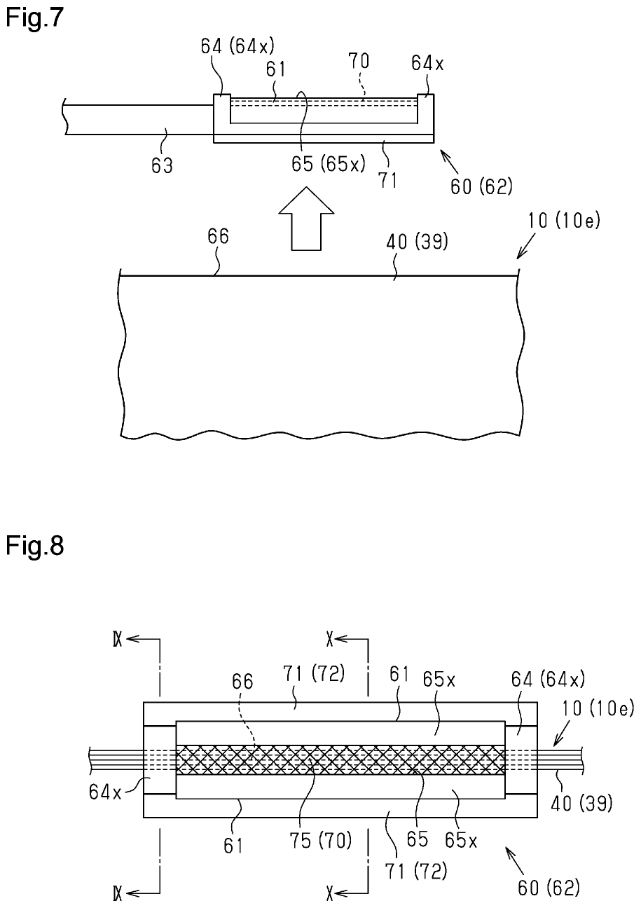

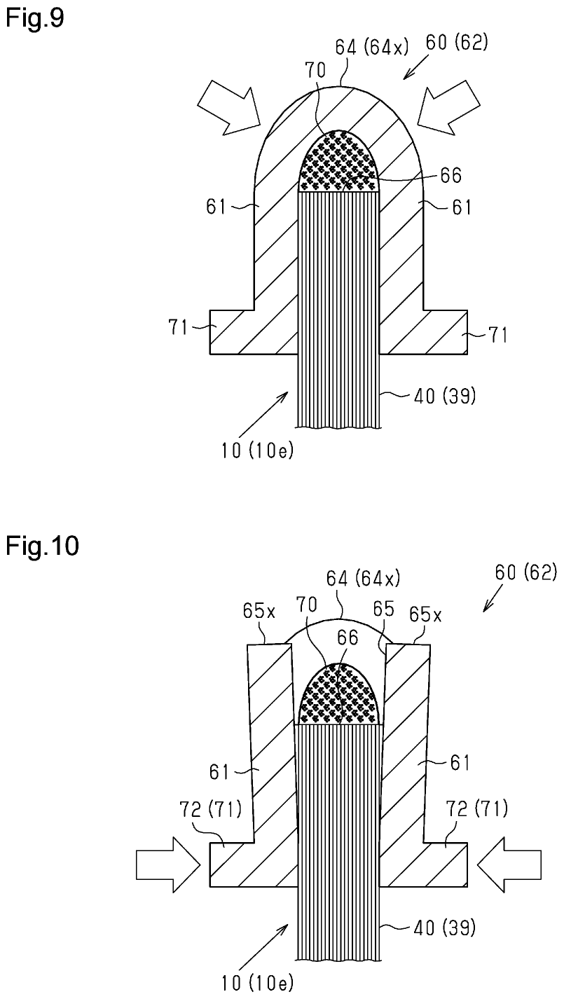

As shown in FIGS. 7, 9, and 10, the current collector 60 is attached to the axial end 10e of the electrode body 10 in a state in which a brazing material 70 is arranged in the opening 65 of the top part 64 of the folded portion 62 in advance. Thus, the brazing material 70 is disposed along the edges 66 of the electrode plate end portions 40 held between the two holding walls 61 of the folded portion 62 of the current collector 60.

Specifically, as shown in FIGS. 7 to 9, the two holding walls 61 of the current collector 60 are swaged with the brazing material 70 held between the holding walls 61 at the top part 64 of the folded portion 62. More specifically, two bent portions 64x, each having a substantially U-shaped cross section remaining in the top part 64, are swaged at the two ends of the opening 65 that extends in the longitudinal direction (sideward direction in FIG. 7) of the folded portion 62. This supports the brazing material 70 between the bent portions 64x. In the rechargeable battery 1 of the present embodiment, an aluminum-silicon based material is used as the brazing material 70 for the positive electrode 3. A copper-silicon based material is used as the brazing material 70 for the negative electrode 4. Further, when joining the current collector 60 to the electrode body 10, the opening 65 in the top part 64 of the folded portion 62 is used to melt the brazing material 70 in the vicinity of the edges 66 of the electrode plate end portions 40 held between the holding walls 61. This brazes the edges 66 of the electrode plate end portions 40, exposed from the opening 65 of the folded portion 62, to the holding walls 61.

As shown in FIG. 10, before brazing is performed as described above, the electrode plate end portions 40 are bound by the holding walls 61 of the folded portion 62 at a position separated from the edges 66 of the electrode plate end portions 40.

Specifically, the current collector 60 includes two flanges 71 on the holding walls 61 at a position separated from an opening end 65x of the opening 65, which is formed in the top part 64 of the folded portion 62 between the holding walls 61. Prior to the brazing, the flanges 71 are pressed from both sides in the thickness-wise direction (sideward direction in FIG. 10) of the electrode plate end portions 40 held between the holding walls 61 using a jig (not shown). This swages the current collector 60 at the position where the flanges 71 are formed, thereby binding the electrode plate end portions 40 in a state in which the holding walls 61 compress the electrode plate end portions 40 held between the holding walls 61.

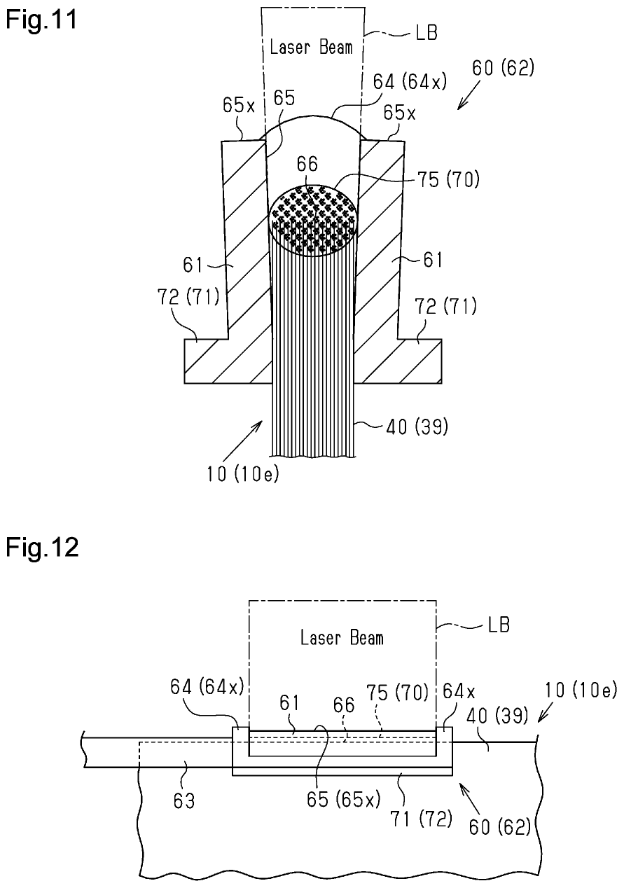

As shown in FIG. 11, a laser beam LB irradiates the brazing material 70, which is disposed on the edges 66 of the electrode plate end portions 40 exposed from the opening 65, through the opening 65 in the top part 64 of the folded portion 62. This melts the brazing material 70. The melted brazing material 70 joins the edges 66 of the electrode plate end portions 40 to the holding walls 61, which hold the electrode plate end portions 40 in the thickness-wise direction. That is, the folded portion 62 of the current collector 60 is brazed to the electrode plate end portions 40 at the axial end 10e of the electrode body 10.

As shown in FIG. 12, a substantially uniform laser beam LB is emitted toward the opening 65 of the folded portion 62 over an entire longitudinal region of the opening 65. The opening 65 extends along the edges 66 of the electrode plate end portions 40 at the axial end 10e of the electrode body 10. In other words, the brazing material 70 in the opening 65 of the folded portion 62 along the edges 66 of the electrode plate end portions 40 is irradiated with a wide laser beam LB having a low light concentration. This brazes the electrode plate end portions 40 held between the holding walls 61 of the folded portion 62 in a state in which heat is uniformly applied to the brazing material 70.

Such a brazing reduces an amount of the heat applied to join the current collector 60 to the axial end 10e of the electrode body 10. Accordingly, the rechargeable battery 1 of the present embodiment restricts thermal denaturation caused by the joining.

This avoids, for example, a situation in which the heat of the electrode plate end portions 40 deteriorates the electrode active material or a situation in which the thermally expanded electrode plate end portions 40 contract and break the electrode plate 31 (“foil breakage”). In the rechargeable battery 1 of the present embodiment, the heat is uniformly applied to the brazing material 70. Thus, occurrences of “foil breakage” are avoided effectively.

As shown in FIGS. 10 and 11, the edges 66 of the electrode plate end portions 40 are disposed between the holding walls 61 at a position separated from the opening end 65x of the opening 65 in the top part 64 of the folded portion 62. Thus, the brazing material 70 melted during brazing is unlikely to fly out of the folded portion 62, which hold the electrode plate end portions 40 between the holding walls 61.

Further, the current collector 60 includes compressing-binding portions 72 formed by pressing the flanges 71 on the holding walls 61 of the folded portion 62 as described above. The compressing-binding portions 72 bind the electrode plate end portions 40 held between the holding walls 61 in a state in which the electrode plate end portions 40 are compressed. Furthermore, when forming the compressing-binding portions 72, the pressing force applied to the parts where the compressing-binding portions 72 are formed widens the opening end 65x of the opening 65 in the top part 64 of the folded portion 62 in the thickness-wise direction of the electrode plate end portions 40 (sideward direction in FIGS. 10 and 11). This facilitates the brazing of the electrode plate end portions 40 through the opening 65.

Specifically, a laser beam LB emitted through the opening 65 uniformly irradiates the brazing material 70 in the opening 65 of the folded portion 62 along the edges 66 of the electrode plate end portions 40. Also, during brazing, the thermally expanded edges 66 of the electrode plate end portions 40 spread so that the melted brazing material 70 enters into the gaps between the electrode plate end portions 40 overlapping one another in the thickness-wise direction. This forms a stable brazing portion 75.

In the current collector of the present embodiment, the compressing-binding portions 72 are formed at the position separated from where the edges 66 of the electrode plate end portions 40 is brazed. Thus, the flow of the brazing material 70 entering into the gaps between the electrode plate end portions 40 is stopped at this position. This avoids occurrences of thermal denaturation, such as deterioration of the electrode active material caused by the heat of the melted brazing material 70.

Arrangement of Current Collector

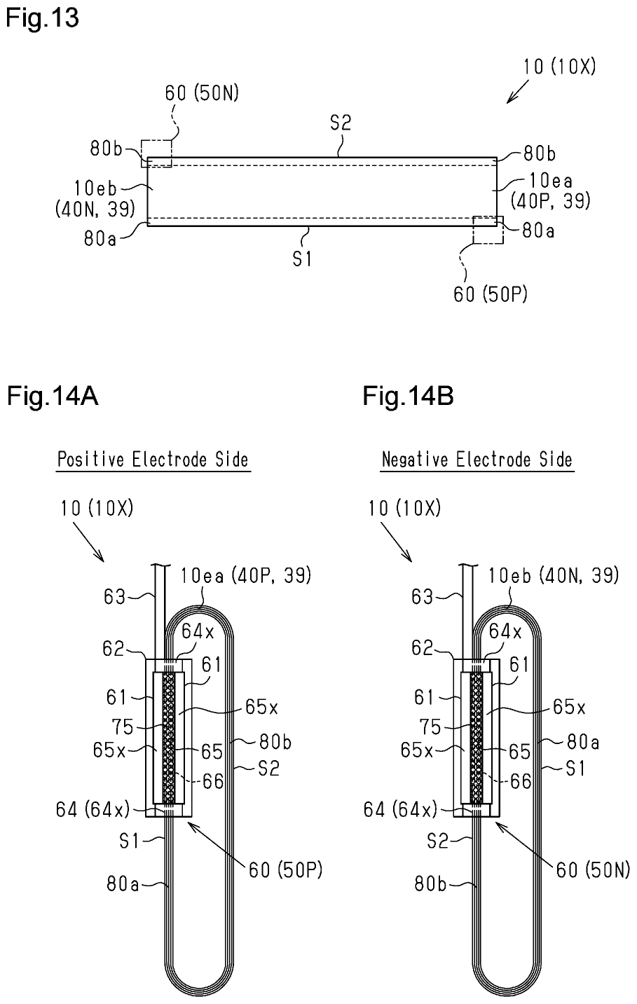

As shown in FIGS. 2, 13, 14A, and 14B, the electrode body 10 of the present embodiment is structured as the rolled body 10X so that the positive electrode plate end portions 40 overlap one another in the thickness-wise direction at the corresponding axial end 10e, and the negative electrode plate end portions 40 overlap one another in the thickness-wise direction at the corresponding axial end 10e. In other words, the electrode body 10 structured as the rolled body 10X includes the first axial end 10ea where the electrode plate end portions 40 of the electrode plate end 40P are arranged and the second axial end 10eb where the electrode plate end portions 40 of the electrode plate end 40N are arranged. Further, the body 10 has a flattened roll shape including first and second flat surfaces S1 and S2 facing opposite directions. At the first axial end 10ea, the current collector 60 is joined to a long portion 80a at the side of the first flat surface S1 of the electrode body 10. At the second axial end 10eb, the current collector 60 is joined to a long portion 80b at the side of the second flat surface S2 of the electrode body 10. In this manner, the rechargeable battery 1 of the present embodiment ensures excellent battery performance qualities.

Operation

When joining the current collector 60 to the electrode plate end portions 40 at the axial end 10e of the electrode body 10, if the current collector 60 is joined to the electrode plate end portions 40 at both of the long portion 80a at the side of the first flat surface Si and the long portion 80b at the side of the second flat surface S2, the circumferential length of the electrode plate end portion 40 before the current collector 60 is joined will differ from that after the current collector 60 is joined.

Specifically, when the current collector 60 is joined to both of the long portion 80a at the side of the first flat surface Si and the long portion 80b at the side of the second flat surface S2, only the joined portion of the axial end 10e of the electrode body 10, structured as the rolled body 10X, will be further flattened. As a result, a large tensile load will be applied to the outermost layer of the electrode plate end portions 40 located at the radially outer side of the rolled body 10X. This may cause “foil breakage” or the like. In order to resolve such a problem resulting from the circumferential length difference, the width of the uncoated portion 39, which is prone to plastic deformation, may be increased. However, this would decrease the area of the electrode plate 31 on which the electrode active material is applied, or the area of the electrode active material layer 32 that acts as an effective electrode.

Accordingly, when the current collector 60 is joined to the axial end 10e of the electrode body 10, structured as the flattened rolled body 10X, the current collector 60 is joined to the electrode plate end portions 40 at only one of the long portions 80a and 80b respectively corresponding to the first and second flat surfaces S1 and S2. This resolves the above-described problem of “circumferential length difference”, thereby allowing the rechargeable battery 1 of the present embodiment to minimize the uncoated portion 39. As a result, the formation area of the electrode active material layer 32 is ensured. Consequently, the battery performance qualities are improved.

In the case of “one-side supporting structure” in which the current collector 60 is joined to the electrode plate end portions 40 at only one of the long portions 80a and 80b, the joining area between the current collector 60 and the electrode plate end portions 40 is smaller than that in the case of “two-side supporting structure” in which the current collector 60 is joined at both of the long portions 80a and 80b. Accordingly, in the rechargeable battery 1 of the present embodiment, the current collector 60 is set such that the joining length a (refer to FIG. 5) of the current collector 60 along the edges 66 of the electrode plate end portions 40, where brazing is performed, is approximately twice as long as that in the case of “two-side supporting structure”. This avoids a situation in which decreases in the joining area increase the resistance of the rechargeable battery 1.

Further, the current collector 60 is joined to the electrode plate end portions 40 at the axial end 10e of the electrode body 10. Thus, the circulation of the electrolyte 51 impregnating the electrode body 10 is hindered at the joining position of the collector 60. The electrolyte 51 flows into the electrode body 10 from the axial ends 10e where the rolled form of the rolled body 10X is exposed. Therefore, the joining state and the joining position of the current collectors 60 with respect to the axial ends 10e of the electrode body 10 greatly affect, for example, the time required for impregnation of the electrode body 10 with the electrolyte 51.

In this respect, the current collectors 60 of the present embodiment are joined to one of the long portions 80a and 80b at the first axial end 10ea and the other one of the long portions 80a and 80b at the second axial end 10eb. Specifically, in the electrode body 10 having such a structure of the rolled body 10X, each of the first and second flat surfaces 51 and S2 has one axial end 10e that is joined to the current collector 60 and another axial end 10e that is not joined to the current collector 60. Thus, the electrode body 10 is readily impregnated with the electrolyte 51.

Further, the electrolyte 51 flows in and out of the electrode body 10 through the axial ends 10e also during charging and discharging of the rechargeable battery 1. Such circulation of the electrolyte 51 during charging and discharging is not likely to be hindered by the current collectors 60 of the present embodiment joined to the axial ends 10e of the electrode body 10. This ensures excellent battery performance qualities.

The present embodiment has the following advantages.

(1) The current collector 60 includes the folded portion 62 that holds the electrode plate end portions 40 overlapping one another in the thickness-wise direction between the two opposing holding walls 61. The current collector 60 is joined to the axial end 10e of the electrode body 10 at which corresponding ones of the positive and negative electrode plate end portions 40 are arranged. Further, the current collector 60 includes the opening 65 in the top part 64 of the folded portion 62, which connects the holding walls 61. The current collector 60 includes the brazing portion 75 that joins the edges 66 of the electrode plate end portions 40, exposed from the opening 65, to the holding walls 61.

With the above structure, the edges 66 of the electrode plate end portions 40 held between the holding walls 61 of the current collector 60 are brazed through the opening 65 formed in the top part 64 of the folded portion 62. Thus, the degree of freedom is increased for joining the current collector 60 to the electrode body 10.

There is no need to divide the layers of the electrode plate end portions 40 overlapping one another in the thickness-wise direction into small sections so that a welding machine can hold the joining parts thereby facilitating welding. This simplifies the joining process of the current collector 60 and improves the productivity.

Further, brazing reduces the amount of heat applied to join the current collector 60 to the axial end 10e of the electrode body 10. This avoids thermal denaturation, such as a situation in which the heat of the electrode plate end portions 40 deteriorates the electrode active material or a situation in which the thermally expanded electrode plate end portions 40 contract and break the electrode plate 31 (“foil breakage”).

Furthermore, the brazing material 70 melted during brazing is unlikely to fly out of the folded portion 62, which hold the electrode plate end portions 40 between the holding walls 61. This avoids occurrences of short-circuiting failure caused by “spatters”, thereby ensuring high reliability.

(2) Prior to brazing, the electrode plate end portions 40 are bound in a state in which the holding walls 61 compress the electrode plate end portions 40 held between the holding walls 61 at a position separated from the edges 66 of the electrode plate end portions

Specifically, the compressing-binding portions 72 are formed at a position separated from the edges 66 of the electrode plate end portions 40. This allows for spreading of the edges 66 of the electrode plate end portions 40 due to thermal expansion during brazing. Further, the spreading of the edges 66 of the electrode plate end portions 40 allows the melted brazing material 70 to enter into the gaps between the electrode plate end portions 40 overlapping one another in the thickness-wise direction. Thus, a stable brazing portion 75 is formed.

Furthermore, the flow of the brazing material 70 entering into the gaps between the electrode plate end portions 40 is stopped at the position where the compressing-binding portions 72 are formed. This avoids occurrences of thermal denaturation, such as deterioration of the electrode active material by the heat of the melted brazing material 70.

(3) The current collector 60 is configured so that the brazing material 70 is arranged in the opening 65 of the top part 64 of the folded portion 62 by holding the brazing material 70 between the holding walls 61.

Specifically, the current collector 60 is attached to the axial end 10e of the electrode body 10 in a state in which the brazing material 70 is held in the opening 65 of the top part 64 of the folded portion 62 in advance. Thus, the brazing material 70 held in the opening 65 is disposed along the edges 66 of the electrode plate end portions 40, which are held between the two holding walls 61 of the folded portion 62. The above structure allows the electrode plate end portions 40 to be readily brazed through the opening 65 in the top part 64 of the folded portion 62.

(4) The electrode plate end portions 40 are brazed by the laser beam LB irradiating the brazing material 70 in the opening 65 of the folded portion 62. This brazes the electrode plate end portions 40 readily and surely.

(5) The current collector 60 is configured so that the opening end 65x of the opening 65 is widened in the thickness-wise direction of the electrode plate end portions.

Specifically, the opening end 65x is wide so that the brazing material 70 in the opening 65 of the folded portion 62 along the edges 66 of the electrode plate end portions 40 is uniformly irradiated by the laser beam LB. Further, the distance between the holding walls 61 of the folded portion 62 is increased toward the side of the top part 64, or toward the opening end 65x of the opening 65. This facilitates the spreading of the edges 66 of the electrode plate end portions 40 held between the holding walls 61 during brazing. Thus, the electrode plate end portions 40 are brazed readily and surely.

The opening end 65x is easily widened by the pressing force applied to form the compressing-binding portions 72 at a position separated from the edges 66 of the electrode plate end portions 40 exposed from the opening 65.

(6) The brazing of the electrode plate end portions 40 is performed by irradiating the brazing material 70 in the opening 65 of the folded portion 62, which extends along the edges 66 of the electrode plate end portions 40, with a substantially uniform laser beam LB over the entire region of the opening 65 in the longitudinal direction.

With the above configuration, heat is uniformly applied to the brazing material 70 in the opening 65 of the folded portion 62 along the edges 66 of the electrode plate end portions 40 during brazing. As a result, the brazing material 70 disposed along the edges 66 of the electrode plate end portions 40 is uniformly melted during brazing. In other words, the heating state at the brazing region of the edges 66 of the electrode plate end portions 40 is set to be substantially uniform during brazing over the entire region. This avoids occurrences of “foil breakage” caused by thermal expansion and cooling effectively.

(7) The electrode body 10 is the rolled body 10X including the first and second axial ends 10ea and 10eb at which the electrode plate end portions 40 having different polarities are arranged. The electrode body 10 has a flattened roll shape including the first and second flat surfaces S1 and S2 facing the opposite directions. At the first axial end 10ea, the current collector 60 is joined to the long portion 80a at the side of the first flat surface S1 of the electrode body 10. At the second axial end 10eb, the current collector 60 is joined to the long portion 80b at the side of the second flat surface S2 of the electrode body 10.

With the above electrode body 10, each of the first and second flat surfaces S1 and S2 has one axial end 10e that is joined to the current collector 60 and another axial end 10e that is not joined to the current collector 60. This maintains smooth circulation of the electrolyte 51 through the axial ends 10e. Thus, the electrode body 10 is readily impregnated with the electrolyte 51.

The smooth circulation of the electrolyte 51 through the axial ends 10e of the electrode body 10 is also maintained during charging and discharging of the rechargeable battery 1. This ensures excellent battery performance qualities.

The above embodiment may be modified as described below. The above embodiment and the following modifications can be combined as long as the combined modifications remain technically consistent with each other.

In the above embodiment, the brazing material 70 is melted by the laser beam LB during brazing. However, there is no limit to such a configuration. The brazing may be performed by other methods such as emission of an electron beam. For example, the brazing material 70 may be melted by a heat source such as a soldering iron. Preferably, the method is capable of uniformly applying heat to the brazing material 70.

The brazing material 70 disposed along the edges 66 of the electrode plate end portions 40 does not have to be irradiated with the substantially uniform laser beam LB over its entire region in the longitudinal direction during brazing. The laser beam LB may be sequentially moved to perform brazing in a stepped manner. The scanning pattern for moving the laser beam LB may also be changed.

In the above embodiment, an aluminum-silicon based material is used as the brazing material 70 for the positive electrode 3, and a copper-silicon based material is used as the brazing material 70 for the negative electrode 4. However, there is no limit to such a configuration. The materials of the brazing material 70 may be changed. Preferably, the material of the brazing material 70 is set such that the brazing portion 75 is integrated with the electrode plate end portions 40.

In the above embodiment, the brazing material 70 is arranged in the opening 65 by holding the brazing material 70 between the holding walls 61 at the top part 64 of the folded portion 62 in advance. However, there is no limit to such a configuration. The brazing material 70 may be disposed on the edges 66 of the electrode plate end portions 40 at the time of brazing by any method.

In the above embodiment, the compressing-binding portions 72 are formed by pressing the flanges 71 on the holding walls 61 of the folded portion 62. However, there is no limit to such a configuration, and the compressing-binding portions 72 may be formed by any method and include any structure. For example, the flanges 71 do not have to be included, and the holding walls 61 may be directly compressed by a jig from both sides in the thickness-wise direction of the electrode plate end portions 40. Such a configuration without the compressing-binding portions 72 is also acceptable.

In the above embodiment, the opening end 65x of the opening 65 in the top part 64 of the folded portion 62 is widened in the thickness-wise direction of the electrode plate end portions 40 by the pressing force applied to form the compressing-binding portions 72. However, there is no limit to such a configuration, and the opening end 65x may be widened by any method. For example, the opening end 65x of the opening 65 may be directly forced outward in an expansion direction. The opening end 65x does not have to be widened.

The above embodiment is applied to the electrode body 10 of the rechargeable battery 1 having a structure of the rolled body 10X in which a stack of the positive and negative electrode sheets 35P and 35N is rolled with the separator 5 held in between. However, the above embodiment is not limited as such and may be applied to, for example, the current collector 60 joined to the electrode body 10 that is formed by a stack of flat layers. In an example, the electrode body 10 includes a stack of flat layers of electrode sheets 35P and electrode sheets 35N. In this case, the electrode sheets 35P may include the electrode plate end portions 40 overlapping one another in the thickness-wise direction at one end of the electrode body 10. Further, the electrode sheets 35N may include the electrode plate end portions 40 overlapping one another in the thickness-wise direction at the other end of the electrode body 10.

The above method is applied to the rechargeable battery 1 structured as a lithium-ion rechargeable battery. However, there is no limit to such a configuration, and the method may be applied to other types of batteries.

The shape of the external terminal is not limited to that shown in FIGS. 1 and 3 to 5 and may be changed. The shape of the case 20 that defines the shape of the rechargeable battery 1 is not limited to the form of a flat box and may be, for example, cylindrical.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A method for joining a current collector, the method comprising:
providing an electrode body that includes electrode plate end portions overlapping each other in a thickness-wise direction of the electrode plate end portions;
providing a current collector including a folded portion, wherein the folded portion includes two opposing holding walls that hold the electrode plate end portions of the electrode body in between, and a top part that connects the two holding walls and includes an opening; and
brazing edges of the electrode plate end portions, exposed from the opening of the top part, to the two holding walls to join the current collector to the electrode body.

2. The joining method according to claim 1, further comprising:
prior to the brazing, binding the electrode plate end portions in a state in which the two holding walls compress the electrode plate end portions held between the two holding walls at a position separated from the edges of the electrode plate end portions.

3. The joining method according to claim 1, further comprising:
arranging a brazing material in the opening by holding the brazing material between the two holding walls at the top part of the folded portion.

4. The joining method according to claim 1, wherein the brazing is performed by uniformly applying heat to the brazing material in the opening along the edges of the electrode plate end portions.

5. The joining method according to claim 1, the brazing is performed by irradiating the brazing material in the opening with a laser beam.

6. A collector joining structure, comprising:
an electrode body that includes electrode plate end portions overlapping each other in a thickness-wise direction of the electrode plate end portions;
a current collector including a folded portion, wherein the folded portion includes two opposing holding walls that hold the electrode plate end portions of the electrode body in between, and a top part that connects the two holding walls and includes an opening; and
a brazing portion that joins edges of the electrode plate end portions, exposed from the opening of the top part, to the two holding walls.

7. The collector joining structure according to claim 6, further comprising:
a compressing-binding portion that binds the electrode plate end portions at a position separated from the edges of the electrode plate end portions in a state in which the two holding walls compress the electrode plate end portions held between the two holding walls.

8. The collector joining structure according to claim 6, wherein an opening end of the opening is widened in a thickness-wise direction of the electrode plate end portions.

9. The collector joining structure according to claim 6, wherein:
the electrode plate end portions include first electrode plate end portions having a first polarity and second electrode plate end portions having a second polarity differing from the first polarity;
the electrode body is a rolled body that includes a first axial end at which the first electrode plate end portions are arranged and a second axial end at which the second electrode plate end portions are arranged, wherein the electrode body has a flattened roll shape including a first flat surface and a second flat surface facing opposite directions;
at the first axial end, the current collector is joined to a long portion at a side of the first flat surface; and
at the second axial end, the current collector is joined to a long portion at a side of the second flat surface.

10. A battery, comprising:
the joining structure according to claim 6.
